(19) United States
(12) Patent Application Publication
(10) Pub. No.: US 2011/0286034 A1
(43) Pub. Date: Nov. 24, 2011

(54) Information processing apparatus and non-transitory computer-readable recording medium

(75) Inventor: Yuuki Hirano, Kanagawa (JP)

(73) Assignee: Ricoh Company, Ltd., Tokyo (JP)

(21) Appl. No.: 13/067,147

(22) Filed: May 12, 2011

(30) Foreign Application Priority Data
May 18, 2010 (JP) 2010-114664

(51) Int. Cl. G06K 15/00

(52) U.S. Cl. 358/1.15

(57) ABSTRACT

An information processing apparatus is disclosed, including an application, a user interface part, a storage part, an image processing part, and a sending part. The application issues a drawing instruction and outputs drawing data. The user interface part performs a print setting with respect to the drawing data. The storage part stores a setting file in which parameters of an allocation process are set. The image processing part performs the allocation process on the drawing data based on the setting file read out from the storage part when the print setting using the setting file is determined by the user interface part. The sending part sends the drawing data on which the allocation process is performed by the image processing part, to an output destination.

### BACKGROUND OF THE INVENTION

1. Field of the Invention

The present invention is related to an information processing apparatus and a non-transitory computer-readable recording medium.

2. Description of the Related Art

In a case of printing at a printer, it has been desired to save paper resources. Thus, a technology is applied to print-outs using a print setting screen provided by a printer driver, so as to allocate multiple pages (2 pages, 4 pages, 6 pages, 9 pages, 16 pages, or the like) to one paper sheet. As applied technologies of aggregate printing, a layout technology has been known in which an order of the aggregate printing is changed by aligning pages from an upper left to a lower right, from an upper right to a lower left, or the like. Also, a printing and bookbinding technology has been already known in which a book is formed by folding and layering printed paper sheets.

Detailed examples of the printing and bookbinding technology will be described with reference to FIG. 1 and FIG. 2. FIG. 1 is a diagram illustrating a detailed example of the aggregate printing. As illustrated in FIG. 1, when the aggregate printing is set, a printer performs a process for reducing and allocating logical pages to one logical page, and performs a print process on a physical paper sheet for each of logical pages. The aggregate printing is performed for “1 in 1” (one page in one page), “2 in 1” (two pages in one page), and “4 in 1” (four pages in one page).

FIG. 2 is a diagram illustrating an example of the printing and bookbinding. As illustrated in FIG. 2, when the printing and bookbinding is set, a printer driver performs the reducing and allocating of logical pages to one logical page and performs the print process on a physical paper sheet for each of the logical pages, similar to the aggregate printing. In this example of the printing and bookbinding in FIG. 2, six pages are printed and bound.

Next, the layout technology will be described. FIG. 3A through FIG. 3D are diagrams illustrating examples of page placement. If an upper side is a first priority and a left side is a second priority in a paper sheet, a page placement order is set to be a sequence of an upper left, an upper right, a lower left, and a lower right in the paper sheet as illustrated in FIG. 3A. If the left side is the first priority and the upper side is the second priority, the page placement order is set to be a sequence of the upper left, the lower left, the upper right, and the lower right as illustrated in FIG. 3B. If the upper side is the first priority and a right side is the second priority, the page placement order is set to be a sequence of the upper right, the upper left, the lower right, and the lower left as illustrated in FIG. 3C. If the right side is the first priority and the upper side is the second priority, the page order is set to be a sequence of the upper right, the lower right, the upper left, and the lower left as illustrated in FIG. 3D.

Next, a UI (User Interface) for setting the aggregate printing and the layout will be described. FIG. 4 is a diagram illustrating examples of setting screens. A setting screen 401 is an example of a setting screen related to the aggregate printing. A user selects one of options: “NOT AGGREGATED”, “AGGREGATE 2 PAGES INTO 1 PAGE (2 in 1)”, and “AGGREGATE 4 PAGES INTO 1 PAGE (4 in 1)”, by using a cursor.

Next, the user sets a placement (layout) of pages. A setting screen 402 is an example of a setting screen related to page placement. Options of the page placement as illustrated in FIG. 3A through FIG. 3D are described by letters. The user selects one of the options: “UPPER LEFT=>UPPER RIGHT=>LOWER LEFT=>LOWER RIGHT”, “UPPER LEFT=>LOWER LEFT=>UPPER RIGHT=>LOWER RIGHT”, “UPPER RIGHT=>UPPER LEFT=>LOWER RIGHT=>LOWER LEFT”, AND “UPPER RIGHT=>LOWER RIGHT=>UPPER LEFT=>LOWER LEFT”, by using a cursor. The user conducts settings of the aggregate printing at the setting screens 401 and 402 as illustrated in FIG. 4.

Also, it has been desired to perform the aggregate printing with an aggregation count of pages and layout positions other than a predetermined aggregation count and layout positions. Japanese Laid-open Patent Publication No. 2002-140176 discloses that the aggregation count and an aggregation order related to the aggregation print are indicated by numeric values.

However, in the above-conventional technologies, print settings other than predetermined layout positions, sizes, angles, repetition of a page, and a like are not allowed for the user to select. Thus, the user can not flexibly determine settings related to the aggregate printing.

### SUMMARY OF THE INVENTION

The present invention solves or reduces one or more of the above problems.

In one aspect of this disclosure, there is provided an information processing apparatus, including an application configured to issue a drawing instruction and output drawing data; a user interface part configured to conduct a print setting with respect to the drawing data; a storage part configured to store a setting file in which parameters of an allocation process are set; an image processing part configured to perform the allocation process on the drawing data based on the setting file read out from the storage part when the print setting using the setting file is determined by the user interface part; and a sending part configured to send the drawing data to which the allocation process is performed by the image processing part, to an output destination.

In another aspect of this disclosure, there is provided a non-transitory computer-readable recording medium storing a program which, when executed by a computer in an information processing apparatus including an application for issuing a drawing instruction and outputting drawing data, causes the computer to perform a process including conducting a print setting with respect to the drawing data; performing an allocation process on the drawing data based on a setting file read out from a storage part, which stores the setting file in which parameters of the allocation process are set, when the print setting using the setting file is determined by a user interface part; and outputting the drawing data on which the allocation process is performed to a spooler.

### BRIEF DESCRIPTION OF THE DRAWINGS

In the following, embodiments of the present invention will be described with reference to the accompanying drawings.

FIG. 1 is a diagram illustrating a detailed example of aggregate printing;

FIG. 2 is a diagram illustrating an example of printing and bookbinding;

FIG. 3A through FIG. 3D are diagrams illustrating examples of page placement;

FIG. 4 is a diagram illustrating examples of setting screens;

FIG. 5 is a diagram illustrating an example of a schematic configuration of a print control system in a first, embodiment;

FIG. 6 is a block diagram illustrating an example of a hardware configuration of an information processing apparatus in the first embodiment;

FIG. 7 is a block diagram illustrating an example of a functional configuration of a PC in the first embodiment;

FIG. 8A through FIG. 8F are diagrams illustrating various examples of the aggregate printing in the first embodiment;

FIG. 9A is a diagram illustrating an example of a free page placement order in the first embodiment, and FIG. 9B is a diagram illustrating an example of script code described in the setting file in the first embodiment;

FIG. 10 is a diagram illustrating an example of the setting file for a custom 1 illustrated in FIG. 8A in the first embodiment;

FIG. 11 is a diagram illustrating an example of the setting file of a custom 3 illustrated in FIG. 8C in the first embodiment;

FIG. 12 is a diagram illustrating an example of the setting file of a custom 4 illustrated in FIG. 8D in the first embodiment;

FIG. 13 is a diagram illustrating an example of the setting file of a custom 5 illustrated in FIG. 8E in the first embodiment;

FIG. 14 is a diagram illustrating an example of a print setting screen for selecting one of setting options including one or more examples of the aggregate printing illustrated in FIG. 8A through FIG. 8F in the first embodiment;

FIG. 15 is a diagram illustrating a scenario example of a RAW spool in the first embodiment;

FIG. 16 is a flowchart for explaining an example of a page edit in the RAW spool in the first embodiment;

FIG. 17A and FIG. 17B are sequence diagrams illustrating an example of RAW spool printing in the first embodiment;

FIG. 18 is a block diagram illustrating an example of a functional configuration of a PC in a second embodiment;

FIG. 19 is a diagram illustrating a scenario example of an EMF spool in the second embodiment;

FIG. 20A and FIG. 20B are sequence diagrams illustrating an example of EMF spool printing in the second embodiment; and

FIG. 21 is a block diagram illustrating an example of an MFP in a variation of the second embodiment.

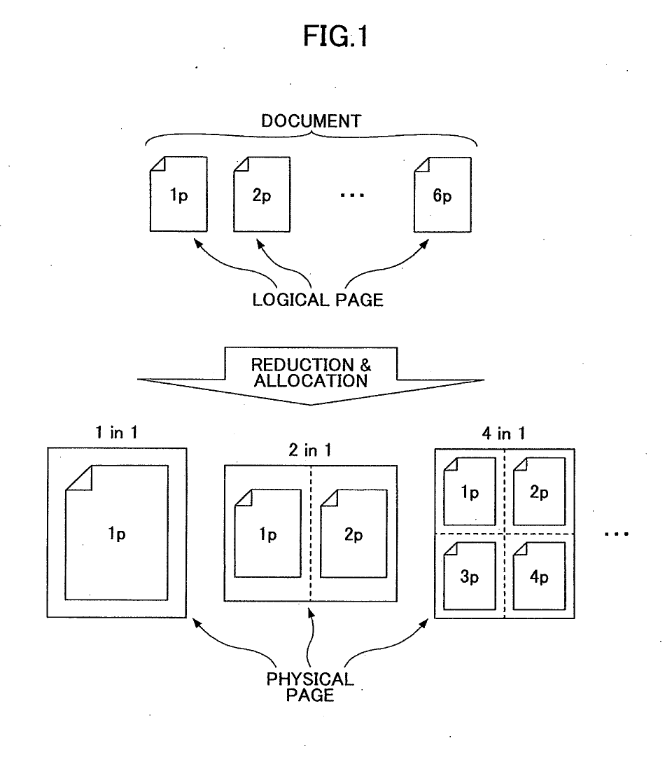

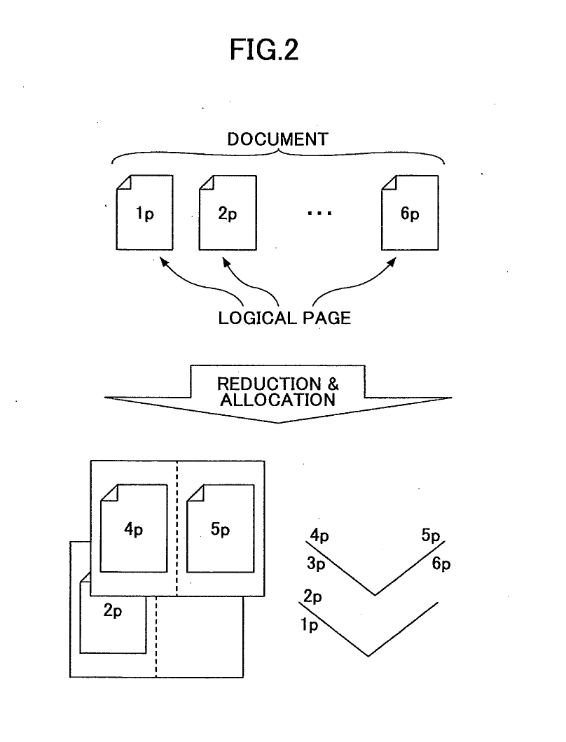

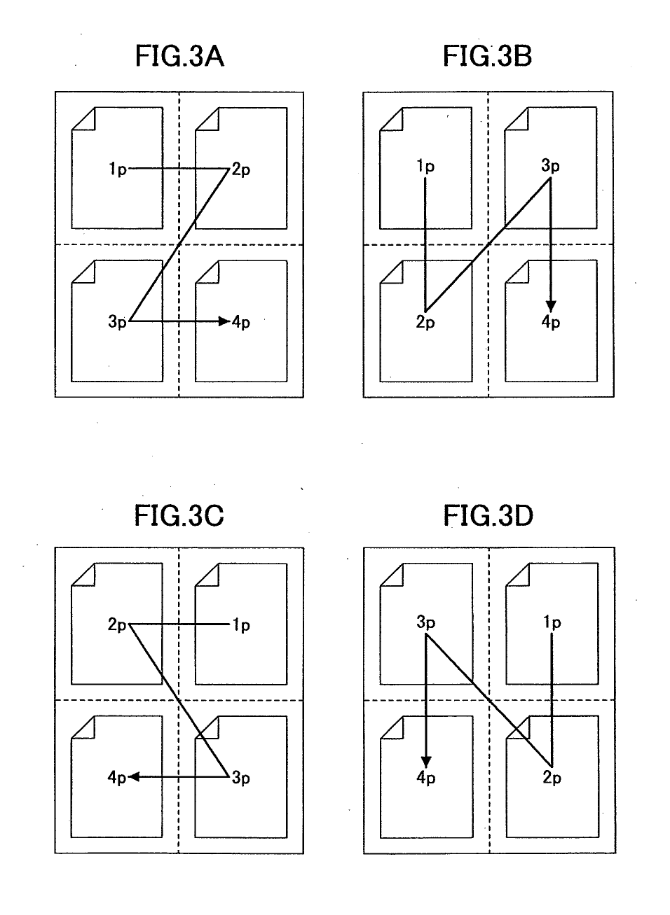

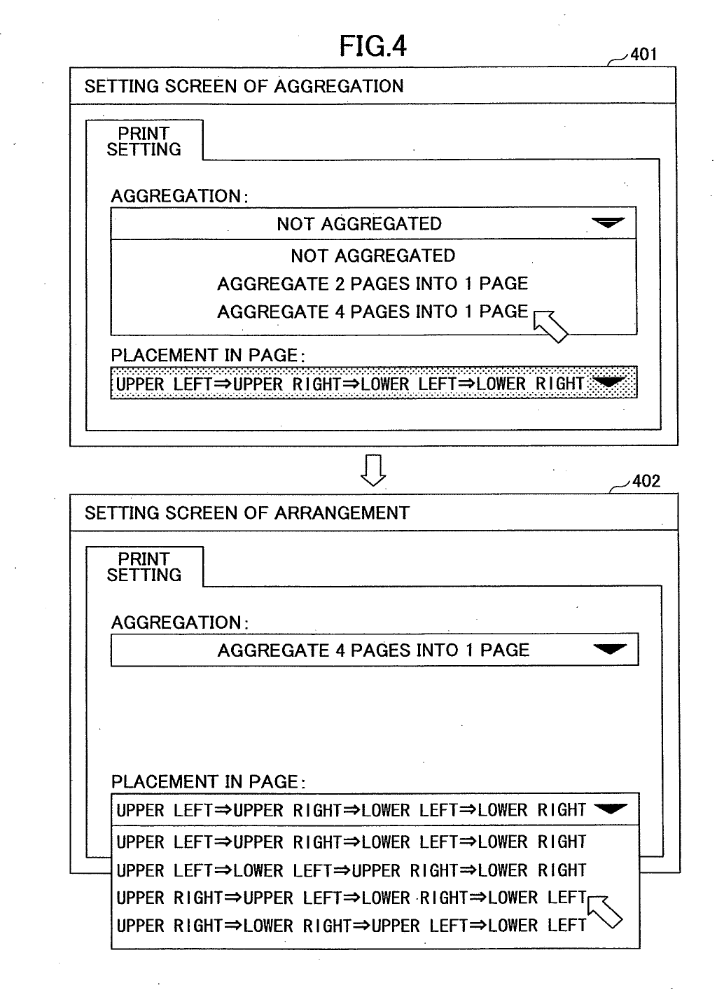

### DESCRIPTION OF THE PREFERRED EMBODIMENTS

In the following, an embodiment according to the present invention will be described with reference to the accompanying drawings. An information processing apparatus (hereinafter, also called a PC (Personal Computer)), a print control system, an image forming apparatus, a computer program, and a non-transitory computer-readable recording medium thereof will be described.

In embodiments described below, an apparatus for outputting image data may be a MFP (MultiFunction Peripheral) which includes a printer function, a scanner function, a copy function, and a facsimile function in a single housing. Also, the apparatus may be a printing apparatus (for example, a printer) including at least a function for outputting image data.

### First Embodiment

### <System Configuration and Hardware Configuration>

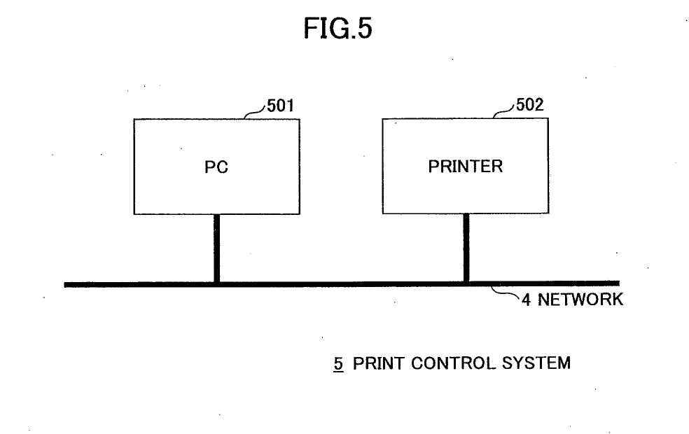

In a first embodiment, first, a system configuration of a print control system and a hardware configuration of an information processing apparatus will be described. FIG. 5 is a diagram illustrating an example of a schematic configuration of the print control system. As illustrated in FIG. 5, a print control system 5 is connected to a PC 501 and a printer 502 through a network 4. The PC 501 illustrated in FIG. 5 converts drawing data indicated to be printed out into print data interpretable for the printer 502. The print data are sent to the printer 502 through the network 4.

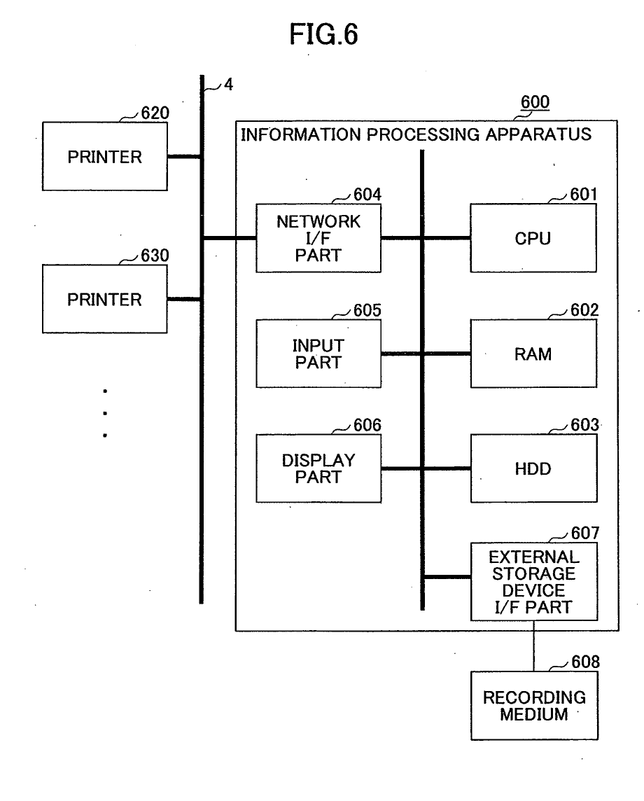

In this example illustrated in FIG. 5, one PC 501 as the information processing apparatus and one printer 502 are connected through the network 4. Also, multiple PCs as multiple information processing apparatuses and multiple printers 502 may be connected through the network 4. The PC 501 may be configured as an information processing apparatus 600 illustrated in FIG. 6.

FIG. 6 is a block diagram illustrating an example of a hardware configuration of the information processing apparatus 600. As illustrated in FIG. 6, the information processing apparatus 600 includes a processor such as a CPU (Central Processing Unit) 601, a main memory such as a RAM (Random Access Memory) 602, a HDD (Hard Disk Drive) 603, a network I/F part 604, an input part 605, a display part 606, and an external storage device I/F part 607.

The CPU 601 includes an arithmetic/logic unit which controls hardware devices in the information processing apparatus 600, and calculates and processes data. The CPU 601 executes a program stored in the RAM 602, receives data from the input part 605 or the HDD 603, calculates and processes the data, and outputs a result to the display part 606 or the HDD 603.

The RAM 602 is used to store or temporarily maintain programs such as an OS (Operating System) as basic software, application software, and the like, which are executed by the CPU 601.

The HDD 603 is used to store data related to the application software. The HDD 603 and/or the RAM 602 may form a storage unit.

The network I/F part 604 is regarded as an interface device between the information processing apparatus 600 and each of printers 620 and 630 including a communication function, which are connected through the network 4 such as a LAN (Local Area Network), a WAN (Wide Area Network), or the like which is formed by data transmission channel with a wired and/or a wireless connection.

The input part 605 includes a keyboard including a cursor key, a numeric input key, various function keys, and the like as well as a mouse, a slide pad, and the like to select a key on a display screen at the display unit 606. Also, the input part 605 is regarded as a user interface unit for a user to indicate an operation to the CPU 601 or to input data.

The display part 606 includes a CRT (Cathode Ray Tube), an LCD (Liquid Crystal Display), or the like, and displays corresponding to display data input from the CPU 601.

The external storage device I/F part 607 provides an interface between the information processing apparatus 600 and a recording medium 608 connected through a data transmission path by a USB (Universal Serial Bus) or the like. For example, the recording medium 608 may be formed by a non-transitory (or tangible) computer-readable recording medium such as a flash memory or the like.

A program is stored in the recording medium 608. The program stored in the recording medium 608 is installed into the information processing apparatus 600 through the external storage device I/F part 607. The installed program can be executed by the CPU 601 in the information processing apparatus 600.

### <Functions>

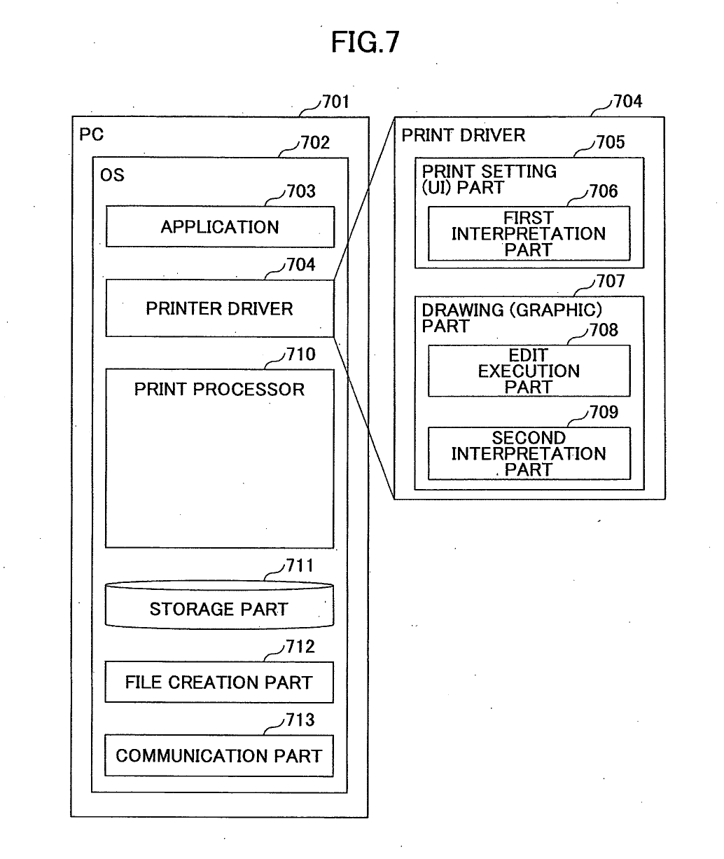

FIG. 7 is a block diagram illustrating an example of a functional configuration of a PC in the first embodiment. As illustrated in FIG. 7, a PC 701 corresponds to the PC 501 configured as the information processing apparatus 600 illustrated in FIG. 6. The PC 701 includes an OS (Operating System) 702, an application 703, a printer driver 704, a print processor 710, a storage part 711, a file creation part 712, and a communication part 713. The storage part 711 may be provided by a part of the storage unit including the HDD 603 and/or the RAM 602 in FIG. 6. It should be noted that in the first embodiment, a case of a print process using a RAW spool will be described.

The OS 702 controls the entire operation of the PC 701. The application 703 is regarded as a general-purpose application (a word processor, a PDF (Portable Document Format) application, or the like). The application 703 receives a print instruction from a user, and outputs DEVMODE to the printer driver 704 as a UI part.

The printer driver 704 controls the printer 502 to print out in accordance with the print instruction sent from the application 703. Also, the printer driver 704 includes a print setting (UI) part 705 and a drawing (graphic) part 707.

The print setting part 705 provides a print setting screen to the user, and allows the user to input print settings of a volume count, an aggregation count, or the like. The print setting part 705 sends the print setting input by the user to the application 703. The print setting part 705 includes a first interpretation part 706.

The first interpretation part 706 interprets parameter information necessary to display on an UI, from a setting file stored in the storage part 711. For example, the parameter information includes a file name. The setting file will be described later.

The drawing part 707 converts data to be printed out into print data interpretable for the printer 502 based on the print settings set by the print setting part 705 or the application 703. For example, the drawing part 707 conducts a page edit for the aggregate printing or for printing and bookbinding. The drawing part 707 further includes an edit execution part 708 and a second interpretation part 709.

The second interpretation part 709 interprets each of parameters in the setting file stored in the storage part 711, and converts the parameters into information interpretable for the edit execution part 708. For example, the parameters may be converted into information written in a script language. The edit execution part 708 conducts the page edit based on an edit setting provided from the second interpretation part 709. The page edit may be an enlargement, a reduction, a rotation, a parallel movement, or the like. The edit execution part 708 conducts the page edit based on each of the parameters.

The print processor 710 performs an allocation process with respect to the print data. The allocation process includes the rotation, the reduction, the parallel movement, a layout setting, and the like for image data. However, in the first embodiment, in a case of the RAW spool, the print processor 710 does not perform the allocation process.

The storage part 711 stores the setting file. As a setting of the aggregate printing and a setting of printing and bookbinding, the setting file includes the parameters to set a print operation related to the aggregate printing and the printing and bookbinding such as the aggregation count, a layout location, a size, an angle, a repetition of a page, a blank sheet insertion, and the like.

The file creation part 712 creates the above-described setting file, and creates, modifies, or deletes parameters in the setting file. For example, the file creation part 712 may be realized by a text editor to directly create and edit the setting file, or by a GUI application which creates the setting file by determining a placement of a page by the user using a mouse. The communication part 713 communicates with the printer 502 to exchange data. For example, the communication part 713 outputs the drawing data on which the allocation process is performed, to the printer 502.

The OS 702 can be realized by the CPU 601, the RAM 602 as a work memory, and the like.

### <Setting Example>

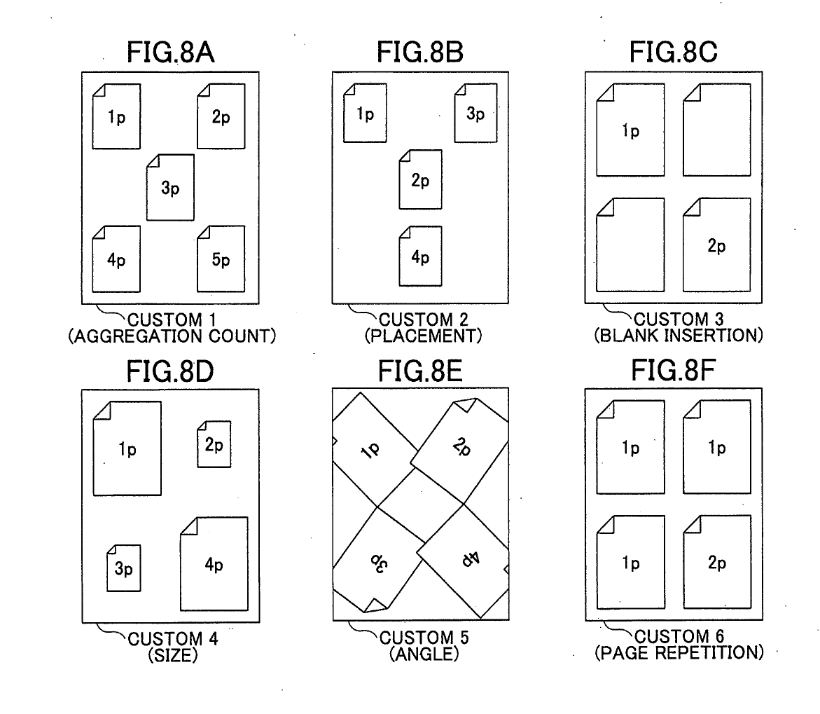

FIG. 8A through FIG. 8F are diagrams illustrating various examples of the aggregate printing. Custom examples in FIG. 8A through FIG. 8F can be realized by the user who creates the setting file by using the file creation part 712. In FIG. 8A through FIG. 8F, a first page, a second page, a third page, and fourth page are referred as a page 1p, a page 2p, a page 3p, and a page 4p.

A custom 1 (aggregation count) illustrates an example of arbitrary aggregation count. In the custom 1 illustrated in FIG. 8A, the aggregation count indicates “5”. A general-purpose printer driver does not allow setting the aggregation count “3”, “5”, or the like. However, in the first embodiment, it is possible to set a parameter of the aggregation count to be “5” in the setting file.

A custom 2 (placement) illustrates an example of a free placement of pages. In the custom 2 illustrated in FIG. 8B, pages are placed in an arbitrary order in accordance with a Y letter shape. The general-purpose printer driver does not allow any order other than a fixed page placement order from an upper left to a lower right. However, in the first embodiment, it is possible to place the pages at arbitrary locations by using the setting file.

A custom 3 (blank insertion) illustrates an example of a free placement of a blank sheet. In the custom 3 illustrated in FIG. 8C, two blank sheets are inserted between the page 1p and the page 2p. The general-purpose printer driver does not allow inserting a blank sheet between pages in the aggregate printing and the printing and bookbinding. However, in the first embodiment, it is possible to insert and place the blank sheet at an arbitrary location by setting a parameter of the blank sheet in the setting file.

A custom 4 (size) illustrates an example of changing sizes of the images (or pages). In the custom 4 illustrated in FIG. 8D, the size of the page 2p and the page 3p are reduced more than other pages 1p and 4p. The general-purpose printer driver does not allow changing the sizes of the pages in the aggregate printing and the printing and bookbinding. However, in the first embodiment, it is possible to set the size for each page by using the corresponding parameter in the setting file.

A custom 5 (angle) illustrates an example of changing an angle for each page. In the custom 5 illustrated in FIG. 8E, each page is rotated approximately 45 degrees.

The general-purpose printer driver does not allow setting the angle for each of the pages in the aggregate printing and the printing and bookbinding. However, in the first embodiment, it is possible to change the angle for each page by using a parameter of the angle of the corresponding page in the setting file.

A custom 6 (page repetition) illustrates an example of repeating an arbitrary page. In the custom 6 illustrated in FIG. 8F, the page 1p is placed and repeated three times. The general-purpose printer driver does not allow repeating the arbitrary page in the aggregate printing and the printing and bookbinding. However, in the first embodiment, it is possible to repeat the arbitrary page by using a parameter of a page repetition in the setting file.

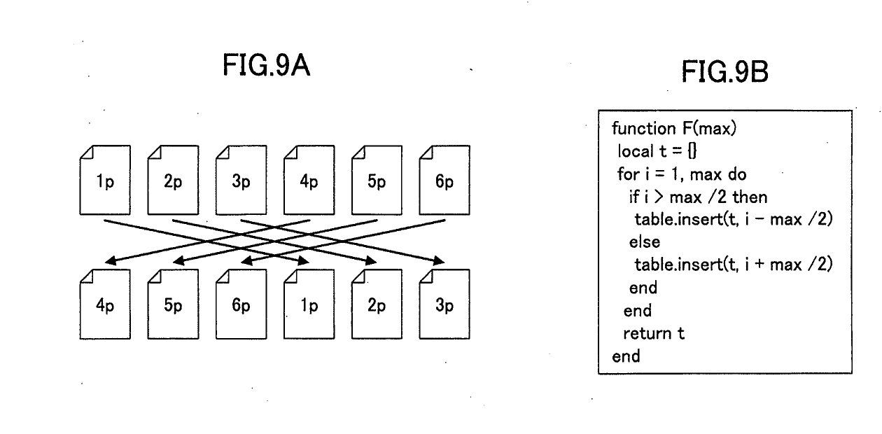

FIG. 9A is a diagram illustrating an example of a free page placement order. In a case of changing the page placement order, if a total page count of a document is required, script code as illustrated in FIG. 9B is placed in the setting file set by the user so as to flexibly change the page order. Also, a function illustrated in FIG. 9B may be used for the page placement order.

### <Setting File>

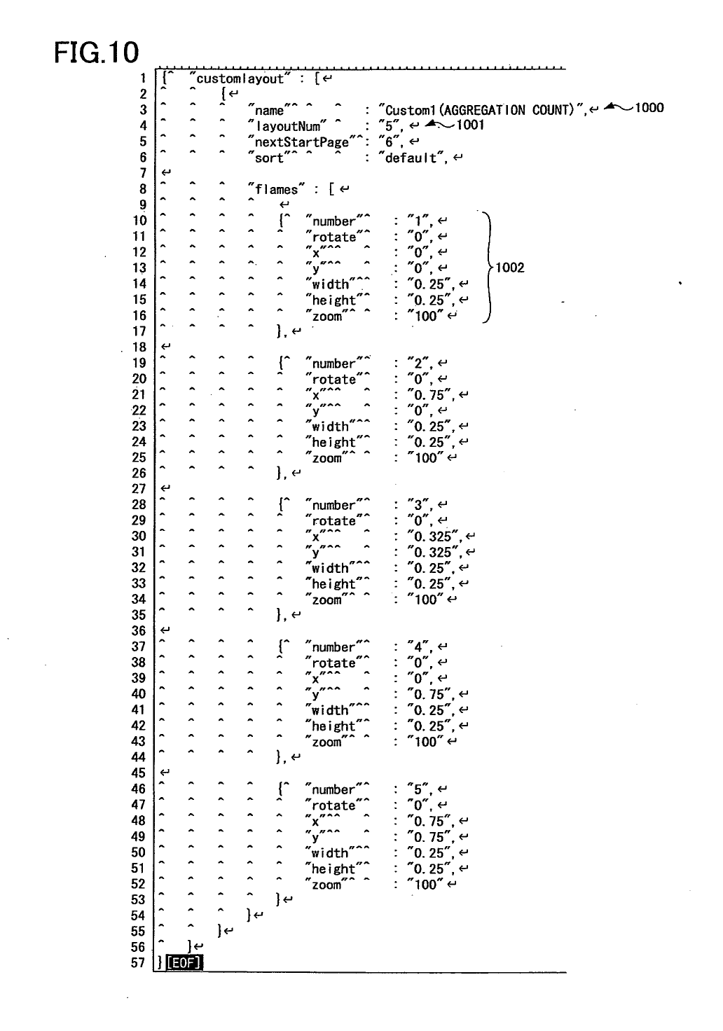

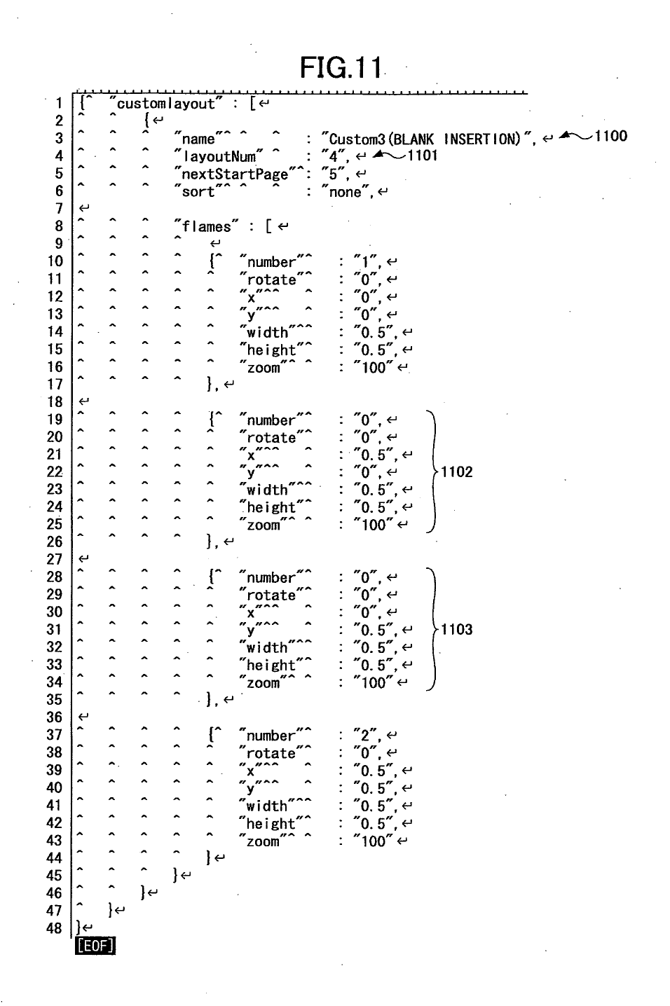

Next, detailed examples of the setting file will be described with reference to FIG. 10 through FIG. 11. FIG. 10 is a diagram illustrating an example of the setting file for the custom 1 illustrated in FIG. 8A. In FIG. 10, a name of the setting file is indicated by a setting value 1000. In this example, the name of the setting file is “Custom 1 (AGGREGATION COUNT)”.

In the setting file, the aggregation count can be set for a “layoutNum” by a setting value 1001. If the “layoutNum” indicates “5”, the aggregation count is set to be “5”. If the “layoutNum” indicates “7”, the aggregation count is set to be “7”.

Setting values 1002 in FIG. 10 are set for parameters. The parameters include a “number” specifying a logical page, a “rotate” indicating an angle, an “x, y, width, height” indicating the location and the size, a “zoom” indicating a magnification, and the like. Each of the parameters is set for each of the logical pages. In the setting file illustrated in FIG. 10, setting information is indicated for one physical page.

FIG. 11 is a diagram illustrating an example of the setting file of the custom 3 illustrated in FIG. 8C. In FIG. 11, a setting value 1100 indicates the name of the setting file. A setting value 1101 indicates “4” as the aggregation count for the “layoutNum”. Setting values 1102 and 1103 in FIG. 11 indicate blank portions. A value “0” for the “number” indicates that the logical page is blank. In the example of the custom 3, there are two same settings in which the “number” indicates the value “0”, between the “number” indicating “1” and the “number” indicating “2”. In this example, as illustrated in FIG. 8C, blank pages are inserted between the logical pages p1 and p2.

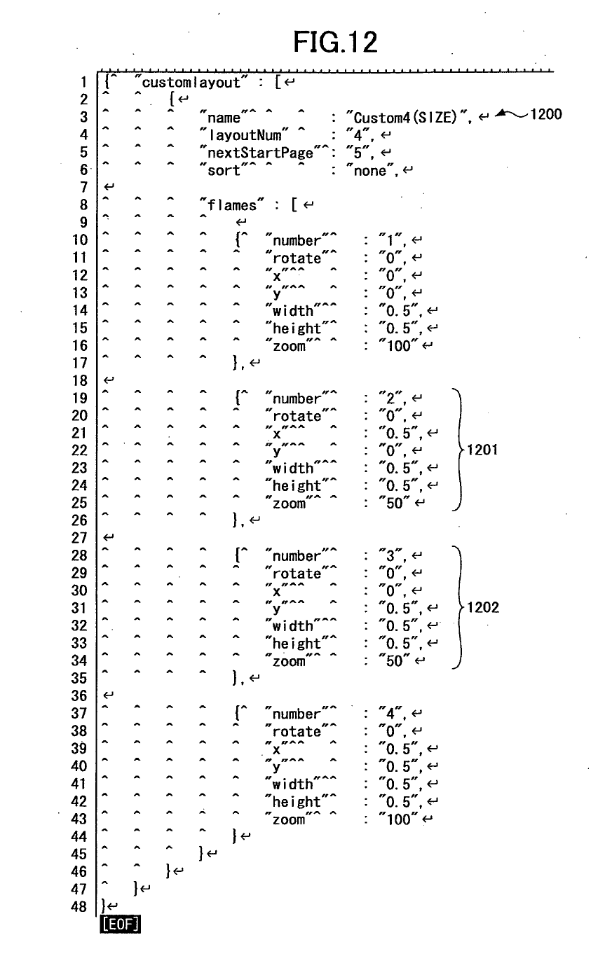

FIG. 12 is a diagram illustrating an example of the setting file of the custom 4 illustrated in FIG. 8D. In FIG. 12, a setting value 1200 indicates the name of the setting file. Setting values 1201 and 1202 in FIG. 12 indicate a value “50” for the parameter “zoom”. That is, the value “50” for the parameter “zoom” indicates 0.5 times in a case that a value “100” is a reference scale as an original size.

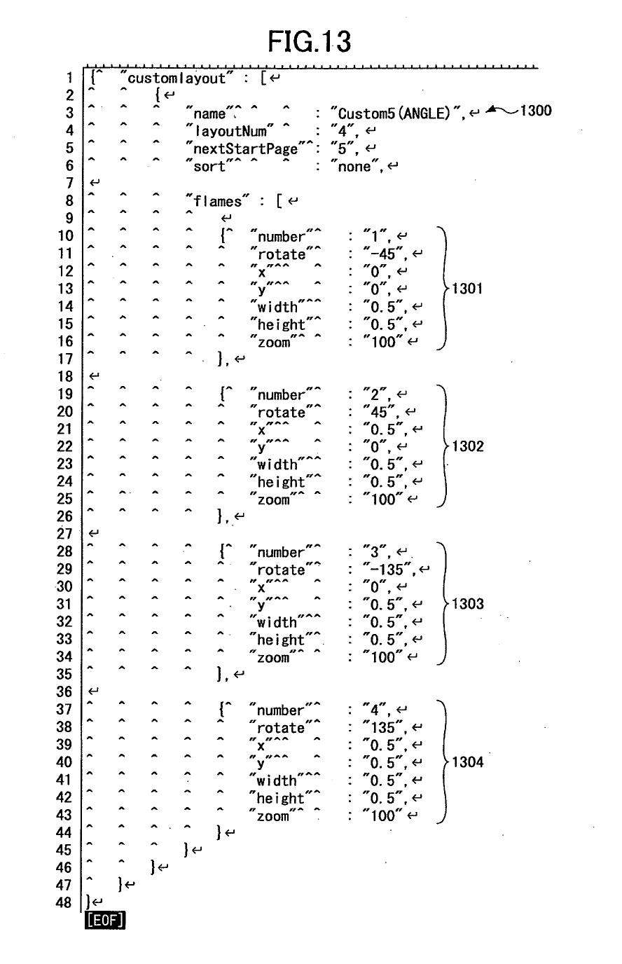

FIG. 13 is a diagram illustrating an example of the setting file of the custom 5 illustrated in FIG. 8E. In FIG. 13, a setting value 1300 indicates the name of the setting file. Setting values 1301, 1302, 1303, and 1304 in FIG. 13 indicate values for parameters for the respective pages. Values “−45”, “45”, “−135”, and “135” are set as the parameter “rotate” for the respective pages. In this example, a positive value indicates a clockwise rotation. That is, based on the values “−45”, “45”, “−135”, and “135” of the parameter “rotate” for the respective pages in FIG. 13, the custom 5 is formed as illustrated in FIG. 8E.

Each of the setting files in FIG. 10 through FIG. 13 is created by the file creation part 712. The setting file may be acquired through the network 4. Alternatively, the setting file may be acquired by copying from a recording medium. Also, the setting file may be a text file, a script file, or the like. In the examples of the setting files in FIG. 10 through FIG. 13, contents are written in a JSON (JavaScript Object Notation) format. Alternatively, the contents may be written in another format such as a XML (Extensible Markup Language) format or the like. The user can freely edit values of the parameters in the setting file by using the file creation part 712.

### <Example of Setting Screen>

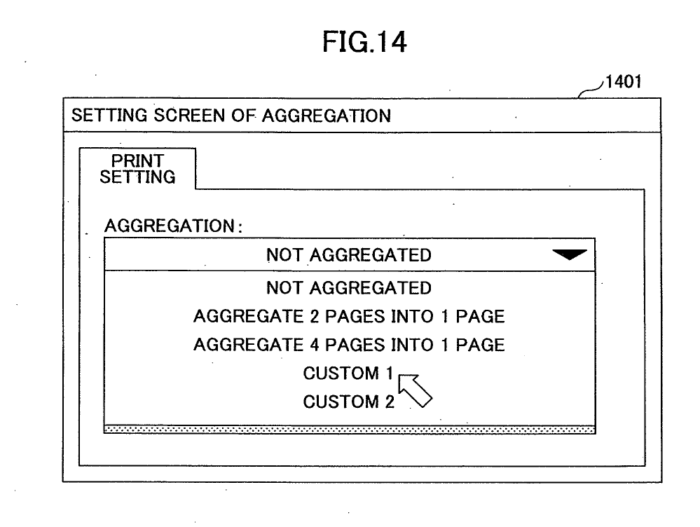

FIG. 14 is a diagram illustrating an example of a print setting screen for selecting setting options including one or more examples of the aggregate printing illustrated in FIG. 8A through FIG. 8F. In a case of a print setting screen 1401 illustrated in FIG. 14, the setting files of the custom 1 and the custom 2 are stored in the storage part 711.

The first interpretation part 706 acquires identification information (for example, a file name) of the setting file stored in the storage part 711. The print setting part 705 additionally includes a “CUSTOM 1” and a “CUSTOM 2”, which are acquired by the first interpretation part 706, into “NOT AGGREGATED”, “AGGREGATE 2 PAGES INTO 1 PAGE”, and “AGGREGATE 4 PAGES INTO 1 PAGE”, which are included beforehand, as options of the aggregate printing.

The print setting part 705 displays the print setting screen 1401 indicating the above options at the display part 606 as illustrated in FIG. 14. Accordingly, the user can select the “CUSTOM 1” or the “CUSTOM 2”, which the user added, from the print setting screen 1401.

### <Scenario>

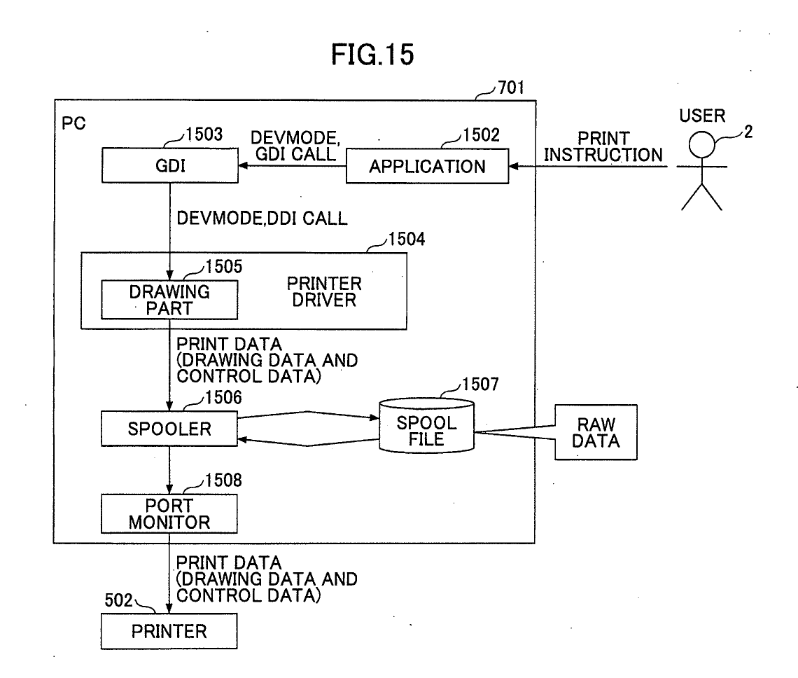

Next, a printing scenario of Windows™ related to the RAW spool will be described. FIG. 15 is a diagram illustrating a scenario example of the RAW spool. In the RAW spool, a drawing part 1505 of a printer driver 1504 converts drawing data into print data written in a print language in accordance with a data format interpretable for the printer 502, when the image data are spooled. The data format depends on a device. In the RAW spool, a proper drawing result can be obtained.

The user conducts a print instruction to an application 1502. When the print instruction is received, the application 1502 outputs the DEVMODE, and makes a GDI (Graphic Device Interface) call regarded as a drawing instruction of a document to a GDI (Graphic Device Interface) 1503.

The GDI 1503 corresponds to a drawing part of the OS 702. The GDI 1503 receives the GDI call from the application 1502, and converts the GDI call into a DDI (Device Driver Interface) call. Then, the GDI 1503 outputs the DEVMODE and makes the DDI call to the drawing part 1505.

When the DDI call is received, the drawing part 1505 converts the drawing data into the print data written in a PDL (Page Description Language) interpretable for the printer 502. The print data include the drawing data written in the PDL and control data. The drawing part 1505 outputs the print data to a spooler 1506.

The spooler 1506 temporarily stores the print data as a spool file (RAW data) 1507. The spooler 1506 outputs the spool file 1507 to a port monitor 1508. The spool file 1507 includes the print data for the RAW data, which are interpretable for the printer 502.

The port monitor 1508 outputs the print data to an output destination which a port number being set indicates.

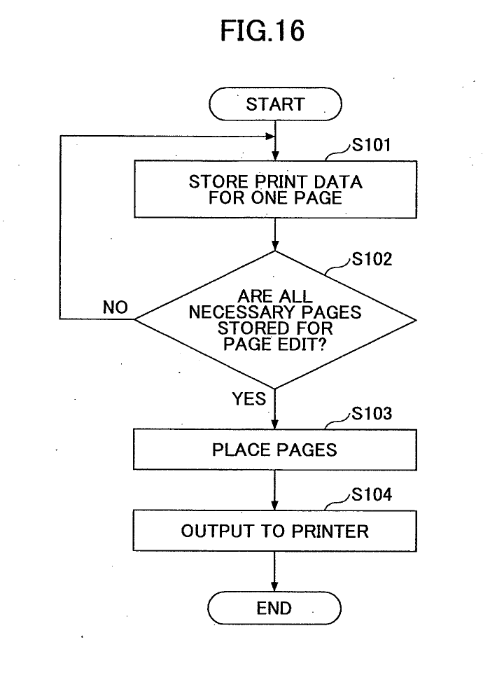

FIG. 16 is a flowchart for explaining an example of a page edit in the RAW spool. In step S101 in FIG. 16, the printer driver 704 cumulatively stores the print data for one page. In the RAW spool, a process is conducted sequentially from a first page.

In step S102, the printer driver 704 determines whether or not all the pages necessary for the page edit are cumulatively stored. For example, the printer driver 704 needs to temporarily store all pages necessary for the aggregate printing. If a determination result indicates that all pages necessary for the page edit are cumulatively stored (YES in the step S102), the printer driver 704 advances to step S103. If the determination result indicates that all pages necessary for the page edit have not been cumulatively stored (NO in the step S102), the printer driver 704 goes back to the step S101.

In the step S103, the printer driver 704 places the pages at respective locations by conducting an aggregate printing process.

In step S104, the printer driver 704 outputs a print command with the print data to the printer 502 through the spooler 1506.

The GDI 1503 and the spooler 1506 are provided as functions by the OS 702. For example, the application 1502, the GDI 1503, the printer driver 1504, and the spooler 1506 are realized by the CPU 601 and the RAM 602 as the work memory. For example, the port monitor 1508 can be realized by the CPU 601 and the network I/F part 604.

### <Operation>

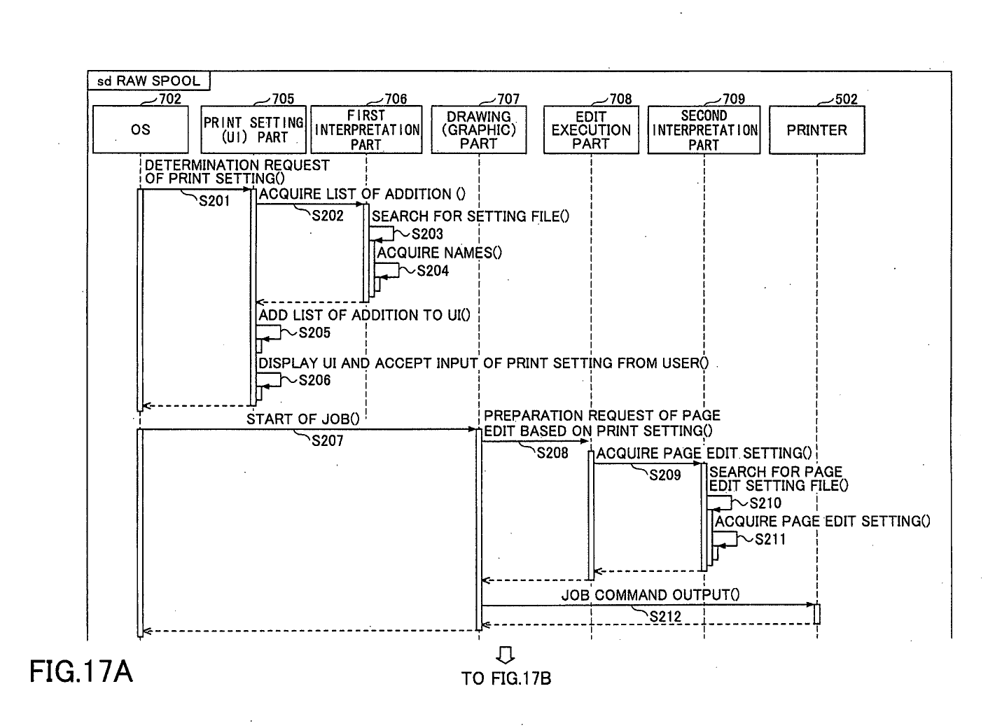

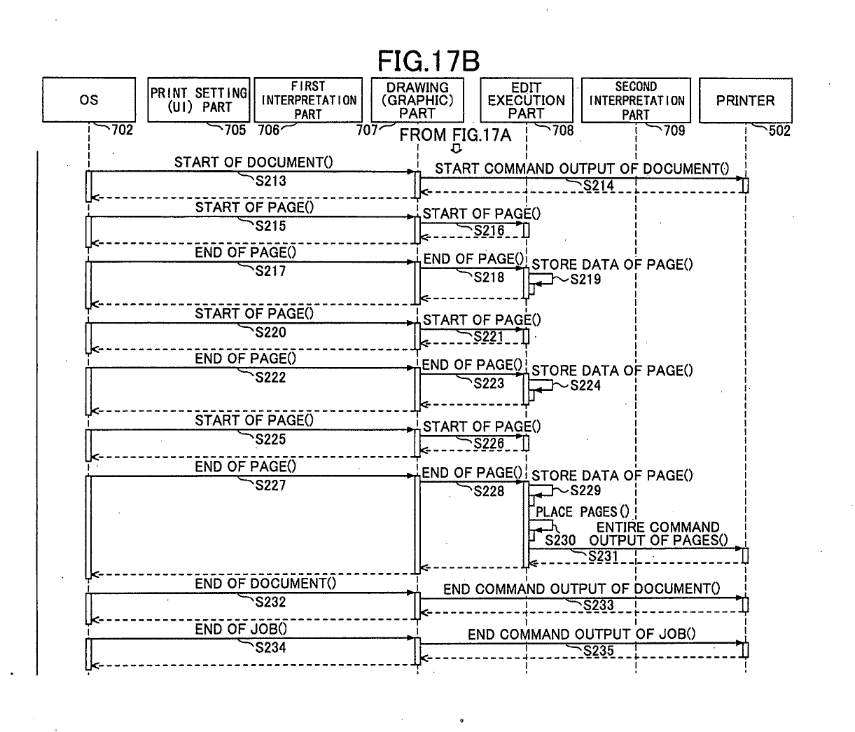

Next, an operation of the print control system 5 in the first embodiment will be described. FIG. 17A and FIG. 17B are sequence diagrams illustrating an example of RAW spool printing. In FIG. 17A and FIG. 17B, an example of aggregate printing of “3 in 1” is illustrated. In step S201, the OS 702 detects a print instruction from the application 703, and sends a determination request of a print setting to the print setting part 705.

In step S202, when the determination request is received from the OS 702, the print setting part 705 sends a request to the first interpretation part 706 to acquire a list of the setting files added by the user.

In step S203 and step S204, the first interpretation part 706 searches for the setting files stored in the storage part 711. For example, the first interpretation part 706 acquires names of the setting files.

In step S205, the print setting part 705 adds the names of the setting files acquired in the step S204 to a selection list of default aggregate printing.

In step S206, the print setting part 705 displays a print setting screen (for example, the print setting screen 1401 in FIG. 14) at the display part 606, and accepts an input of the print setting from the user. When the user determines the print setting, the user presses a print execution button.

In step S207, the OS 702 requests a start of a print job. In step S208, the drawing part 707 requests the edit execution part 708 to prepare the page edit (for example, the allocation process) based on the print setting determined by the user.

In step S209, the edit execution part 708 requests the second interpretation part 709 to acquire the setting file. It is assumed that the user has input “3 in 1” in the step S206. The setting file for the aggregate printing of the “3 in 1” stored in the storage part 711 is acquired by the second interpretation part 709.

In step S210 and step S211, the second interpretation part 709 searches for the setting file corresponding to the “3 in 1” and acquires values of parameters in the searched-for setting file. The acquired values of the parameters are output to the edit execution part 708 and the drawing part 707.

In step S212, the drawing part 707 issues a job command to the printer 502. The printer 502 returns a response to the job command to the drawing part 707. The drawing part 707 outputs the response to the job command to the OS 702.

In step S213, the OS 702 reports a start of the document to the drawing part 707, if the response received from the printer 502 via the drawing part 707 indicates that a job can be started (job start OK).

In step S214, the drawing part 707 issues a command of a document start to the printer 502. The printer 502 returns a response to the command to the drawing part 707. The drawing part 707 outputs the response to the command to the OS 702.

In step S215, the OS 702 reports a start of a page to the drawing part 707, if the response received from the printer 502 via the drawing part 707 indicates that printing of the document can be started (document start OK).

In step S216, the drawing part 707 reports the start of the page to the edit execution part 708. In response to this report from the drawing part 707, the edit execution part 708 starts acquiring page data.

In step S217, the OS 702 reports an end of the page to the drawing part 707.

In step S218, the drawing part 707 reports the end of the page to the edit execution part 708.

In step S219, the edit execution part 708 cumulatively stores the page data in a memory. The memory may be an internal memory or an external memory for the edit execution part 708.

Steps S220 through S224, and steps S225 through S229 are conducted in a manner similar to that of steps S215 through S219. In FIG. 17A and FIG. 17B, since the example of the “3 in 1” is illustrated, processes in steps S215 through S219 are repeated for three pages.

In step S230, the edit execution part 708 arranges data for three pages on a physical page based on the parameters in the setting file.

In step S231, the edit execution part 708 issues a command to the printer 502 to output the data for three pages. The printer 502 returns a response to the command to the edit execution part 708. This response is reported to the OS 702 via the drawing part 707.

In step S232, the OS 702 reports an end of the document to the drawing part 707.

In step S233, the drawing part 707 issues an end command for the document to the printer 502. The printer 502 returns a response to the end command for the document to the drawing part 707. The drawing part 707 outputs the response to the OS 702.

In step S234, the OS 702 reports an end of the job to the drawing part 707.

In step S235, the drawing part 707 issues an end command for the job to the printer 502. The printer 502 outputs a response to the end command of the job to the OS 702 via the drawing part 707.

In the above, according to the first embodiment, in the case of the print process using the RAW spool, by using the setting file in which the parameters for the allocation process are set, the user can conduct a free allocation setting. Accordingly, it is possible to conduct flexible aggregate printing and the printing and bookbinding suitable for requirements of the user.

### Second Embodiment

Next, a print control system in a second embodiment will be described. In the second embodiment, a case of a print process using an EMF (Enhanced MetaFile) spool will be described.

### <Functions>

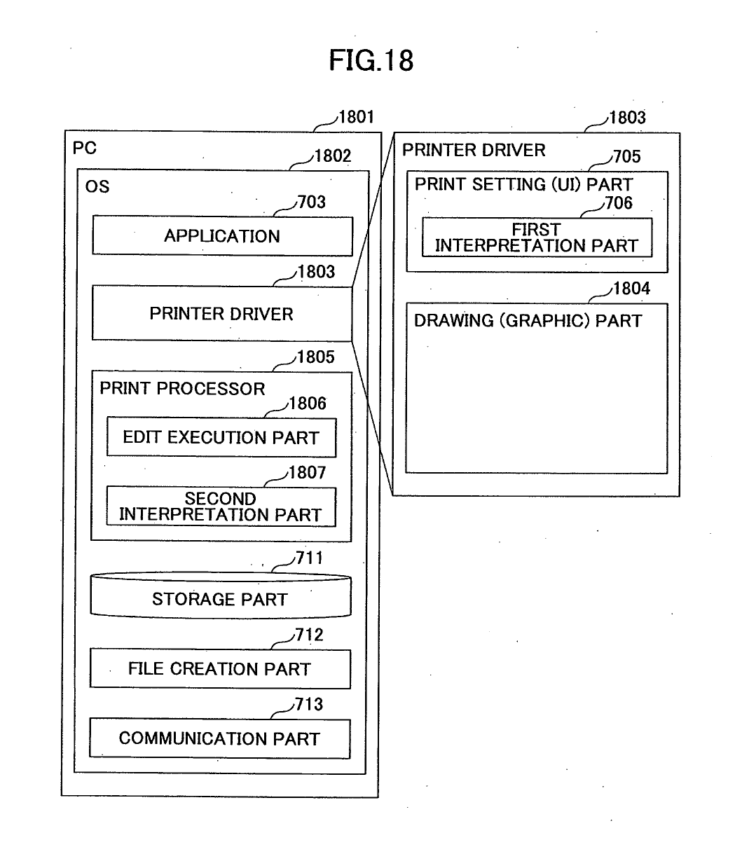

FIG. 18 is a block diagram illustrating an example of a functional configuration of a PC 1801 in the second embodiment. The PC 1801 illustrated in FIG. 18 corresponds to the PC 501 configured as the information processing apparatus 600 illustrated in FIG. 6. The PC 1801 includes an OS (Operating System) 1802, the application 703, a printer driver 1803, a print processor 1805, the storage part 711, the file creation part 712, and the communication part 713. In FIG. 18, functional parts that are the same as the ones in FIG. 7 are indicated by the same reference numerals and an explanation thereof will be omitted.

Different from the first embodiment, the printer driver 1803 illustrated in FIG. 18 conducts a PDL (Page Description Language) conversion without a page edit. The PDL conversion is carried out by the drawing part 1804.

The print processor 1805 performs the allocation process of the page edit related to aggregate printing. The print processor 1805 may determine, from a DEVMODE, whether or not the allocation process is performed for drawing data. Alternatively, the print processor 1805 may directly acquire print setting from attribute information and determine whether or not the allocation process is performed for the drawing data. For example, if the aggregate printing of “2 in 1” is set as the print setting, the print processor 1805 determines that the allocation process is required at least to reduce and rotate each page. The print processor 1805 includes an edit execution part 1806, and a second interpretation part 1807 to conduct the page edit.

The edit execution part 1806 provides a function similar to the edit execution part 708 in the first embodiment.

However, the edit execution part 1806 is included in the print processor 1805. Also, the second interpretation part 1807 provides a function similar to the second interpretation part 709 in the first embodiment. However, the second interpretation part 1807 is included in the print processor 1805.

### <Scenario>

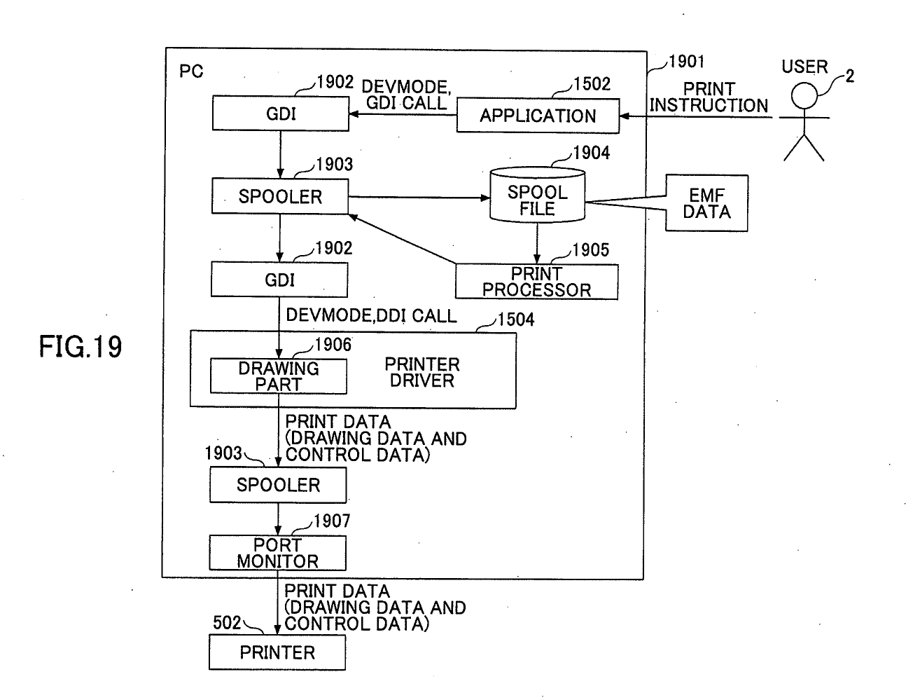

Next, a printing scenario of Windows™ related to the EMF spool will be described. FIG. 19 is a diagram illustrating a scenario example of the EMF spool. The EMF spool applies a common data format in Windows™, and a printer driver 1803 is activated when drawing data are spooled. The common data format is independent of a device. In the EMF spool, since a process consuming time is executed in the background, control is returned to the application 1502 within a short time after a print start instruction is issued. In FIG. 19, functional parts that are the same as those in FIG. 15 are indicated by the same reference numerals and the explanation thereof will be omitted.

As illustrated in FIG. 19, the user conducts a print instruction to the application 1502. When the application 1502 receives the print instruction, the application 1502 outputs the DEVMODE and makes the GDI call regarded as the drawing instruction of a document to the GDI 1902.

The GDI 1902 corresponds to the drawing part of the OS 1802. The GDI 1902 receives the GDI call from the application 1502, and converts the DGI call into the DDI call. Then, the GDI 1902 outputs the DEVMODE and makes the DDI call to the spooler 1903.

The spooler 1903 temporarily stores the acquired EMF data as a spool file 1904. The print processor 1905 acquires the spool file 1904 (EMF data), and performs the allocation process. In this case, the print processor 1905 may performs the allocation process based on the setting file stored in the storage part 711. The print processor 1905 outputs data one which the allocation process is performed, to the spooler 1903.

The spooler 1903 outputs the drawing data on which the allocation process is performed, to the GDI 1902.

The GDI 1902 outputs the drawing data on which the allocation process is performed, to the drawing part 1906 by the DDI call.

The drawing part 1906 converts the acquired drawing data into the print data written in a PDL interpretable for the printer 502. The drawing part 1906 outputs the print data (including the drawing data and the control data) to the spooler 1903.

The spooler 1903 temporarily stores the print data. The spooler 1903 outputs the print data to the port monitor 1907. The port monitor 1907 outputs the print data to an output destination indicated by the port number. The print processor 1905 can be realized by the CPU 601 and the RAM 602 as the work memory.

### <Operation>

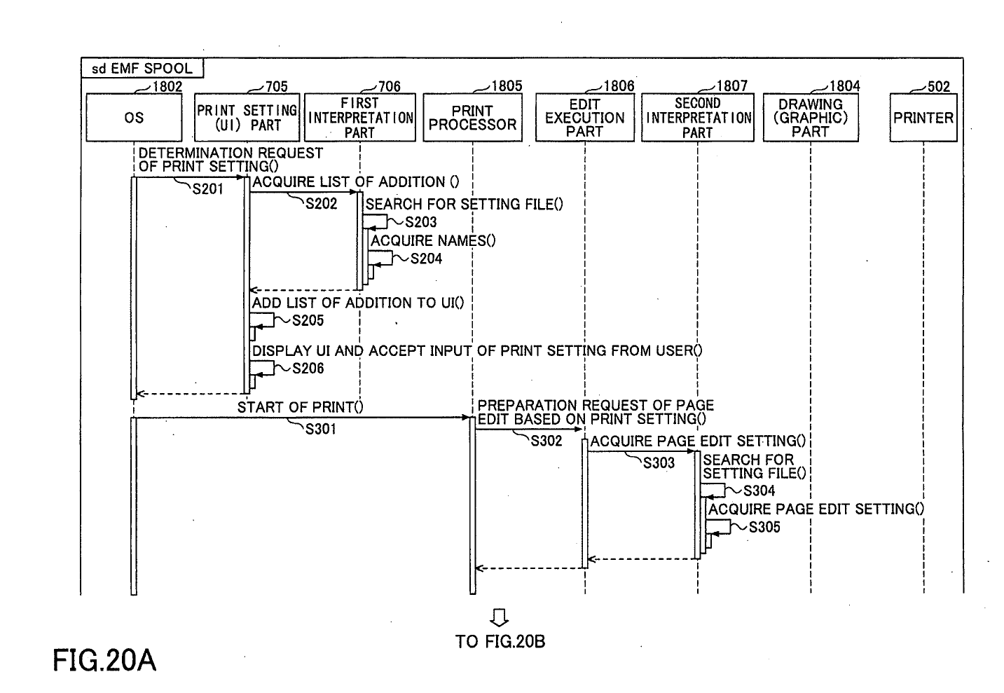

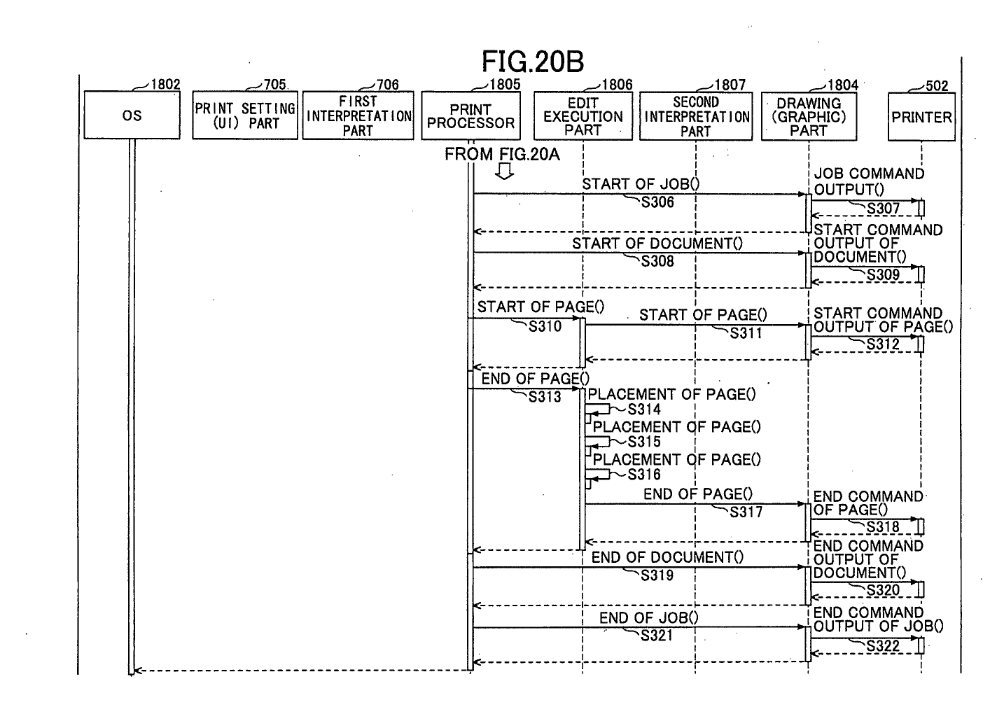

Next, an operation of the print control system in a second embodiment will be described. FIG. 20A and FIG. 20B are sequence diagrams illustrating an example of the EMF spool printing. In FIG. 20A and FIG. 20B, an example of the aggregate printing of the “3 in 1” is illustrated. In FIG. 20A and FIG. 20B, steps that are the same as those in FIG. 17A and FIG. 17B are indicated by the same reference numerals and the explanation thereof will be omitted.

In step S301, the OS 1802 reports a start of a print to the print processor 1805.

In step S302, the print processor 1805 requests the edit execution part 1806 to prepare the page edit based on the print setting selected by the user. In this case, it is assumed that the user selects the print setting (the aggregate printing of the “3 in 1”) corresponding to the setting file which is stored in the storage part 711.

In step S303, the edit execution part 1806 requests the second interpretation part 1807 to acquire setting contents of the page edit.

In step S304, the second interpretation part 1807 searches for the setting file selected by the user in the storage part 711.

In step S305, the second interpretation part 1807 acquires values of parameters described in the searched-for setting file. When the values of the parameters in the setting file are acquired, the second interpretation part 1807 outputs the svalues of the parameters to the print processor 1805 via the edit execution part 1806.

In step S306, the print processor 1805 reports a start of a job to the drawing part 1804.

In step S307, the drawing part 1804 issues a job command to the printer 502. The printer 502 returns a response to the job command to the drawing part 1804. The drawing part 1804 outputs the response to the job command to the print processor 1805.

In step S308, the print processor 1805 reports a start of a document to the drawing part 1804, if the response acquired from the printer 502 via the drawing part 1804 indicates that job can be started (job start OK).

In step S309, the drawing part 1804 issues a command of a document start to the printer 502. The printer 502 returns a response to the command of the document start to the drawing part 1804. The drawing part 1804 outputs the response to the command of the document start to the processor 1805.

In step S310, the print processor 1805 reports a start of a page to the edit execution part 1806, if the response received from the printer 502 via the drawing part 1804 indicates that printing of the document can be started (document start OK).

In step S311, the edit execution part 1806 reports the start of the page to the drawing part 1804.

In step S312, the drawing part 1804 issues a start command of the page to the printer 502. The printer 502 returns a response to the start command of the page to the drawing part 1804. The response to the start command of the page is output to the print processor 1805 via the edit execution part 1806.

In step S313, the print processor 1805 reports an end of the page to the edit execution part 1806.

In steps S314 through 5316, the edit execution part 1806 places three logical pages based on the respective values of the parameters in the setting file. In the EMF spool, since a drawing instruction sent from the application 703 is temporarily stored in an EMF format, the page edit can be conducted by the print processor 1805.

In step S317, the edit execution part 1806 reports an end of the page with the print data being edited, to the drawing part 1804.

In step S318, the drawing part 1804 issues an end command for the page with the print data converted into the PDL, to the printer 502. The printer 502 outputs a response to the end command of the page to the drawing part 1804. The response to the end command of the page is reported to the print processor 1805 via the edit execution part 1806.

In step S319, the print processor 1805 reports an end command of the document to the drawing part 1804.

In step S320, the drawing part 1804 issues the end command of the document to the printer 502. The printer 502 returns a response to the end command of the document to the drawing part 1804. The drawing part 1804 outputs the response to the end command of the document to the print processor 1805.

In step S321, the print processor 1805 reports an end of the job to the drawing part 1804.

In step S322, the drawing part 1804 issues an end command of the job to the printer 502. The printer 502 outputs a response to the end command of the job to the print processor 1805 via the drawing part 1804.

In the above, according to the second embodiment, in a case of the print process using the EMF spool, by using setting file in which the parameters of the allocation process are set, a free layout setting can be conducted by the user. Accordingly, it is possible to conduct the flexible aggregate printing and the printing and bookbinding suitable for requirements of the user.

### <Variation>

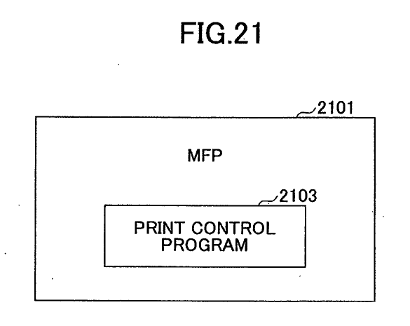

Next, a variation of the image forming apparatus will be described. In the variation, the above-described print control process (printer driver) is embedded in the MFP. FIG. 21 is a block diagram illustrating an example of the MFP in the variation. In FIG. 21, a MFP 2101 includes a processor such as a CPU, a memory, and the like, similar to the hardware configuration in FIG. 6. As illustrated in FIG. 21, the MFP 2101 retains a print control program 2103 in the memory, and generates the print data by executing the print control program 2103. The generated print data are formed as an image and are output. Thus, the MFP 2101 according to the variation can execute the processes described in the first embodiment and the second embodiment by itself.

The above-described programs to be executed by the PC 701 in the first embodiment and the PC 1801 in the second embodiment are recorded in the recording medium 608 which may be a CD-ROM (Compact Disk Read Only Memory), a FD (flexible disk), a CD-R (Compact Disk Recordable), a DVD (Digital Versatile Disk), or the like with a file of an installable format or an executable format. The above-described programs are provided by the recording medium 608. Also, the print control program 2103 to be executed by the MFP 2101 is recorded in a recording medium similar to the recording medium 608, and is provided by the recording medium.

Also, the programs to be executed by the PC 701 in the first embodiment and the PC 1801 in the second embodiment may be stored in a computer connected to the PC 701 and the PC 1801, respectively, through the network 4 such as the Internet or the like, and may be downloaded through the network 4 to be provided. The print control program 2103 to be executed by the MFP 2101 may also be stored and provided from the computer connected to the MFP 2101 through, the network 4 such as the Internet or the like.

Alternatively, the programs to be executed by the PC 701 in the first embodiment and the PC 1801 in the second embodiment may be written beforehand in a ROM (Read Only Memory) or the like to be provided. The print control program 2103 to be executed by the MFP 2101 may also be written beforehand in the ROM (Read Only Memory) or the like to be provided.

Each of the programs in the first and second embodiments and the print control program 2103 in the variation provides a module configuration including the above-described parts. In the hardware configuration as illustrated in FIG. 6, when the processor such as the CPU 601 reads out the program from the recording medium 608 and executes the program, the above-described function is loaded into the main memory such as the RAM 602 and is held in the main memory. In the same manner, each function realized by the print control program 2103 is formed in the memory.

The present invention is not limited to the specifically disclosed embodiments, and variations and modifications may be made without departing from the scope of the invention. Also, variations of the present invention may be formed by appropriately combining multiple functional elements disclosed in the above-described embodiments. For example, one or more functional elements may be deleted from the entire functional elements illustrated in the embodiments. Alternatively, functional elements are selected from different embodiments and appropriately combined.

The present application is based on Japanese Priority Patent Application No. 2010-114664 filed on May 18, 2010, the entire contents of which are hereby incorporated by reference.

What is claimed is:

1. An information processing apparatus, comprising:
an application configured to issue a drawing instruction and output drawing data;
a user interface part configured to perform a print setting with respect to the drawing data;
a storage part configured to store a setting file in which parameters of an allocation process are set;
an image processing part configured to perform the allocation process on the drawing data based on the setting file read out from the storage part when the print setting using the setting file is determined by the user interface part; and
a sending part configured to send the drawing data on which the allocation process is performed by the image processing part, to an output destination.

2. The information processing apparatus as claimed in claim 1, further comprising a file creation part configured to create, modify, or delete the parameters in the setting file.

3. The information processing apparatus as claimed in claim 1, wherein the image processing part is formed by a print processor to perform the allocation process separately from a drawing part of a printer driver.

4. The information processing apparatus as claimed in claim 1, wherein the image processing part is included in a drawing part of a printer driver.

5. The information processing apparatus as claimed in claim 1, wherein the user interface part acquires identification information of the setting file stored in the storage part and displays the identification information as an option at a display part, when options for aggregate printing or a printing and bookbinding are displayed at the display part.

6. A non-transitory computer-readable recording medium storing a program which, when executed by a computer in an information processing apparatus including an application for issuing a drawing instruction and outputting drawing data, causes the computer to perform a process comprising:
performing a print setting with respect to the drawing data;
performing an allocation process on the drawing data based on a setting file read out from a storage part, which stores the setting file in which parameters of the allocation process are set, when the print setting using the setting file is determined by a user interface part; and
outputting the drawing data on which the allocation process is performed to a spooler.

7. The non-transitory computer-readable recording medium as claimed in claim 6, wherein the process further comprises editing the setting file by creating, modifying, or deleting the parameters in the setting file.

8. The non-transitory computer-readable recording medium as claimed in claim 6, wherein the allocation process is performed by a print processor separately from a drawing part of a printer driver.

9. The non-transitory computer-readable recording medium as claimed in claim 6, wherein the allocation process is performed by a drawing part of a printer driver.

10. The non-transitory computer-readable recording medium as claimed in claim 6, wherein the performing the print setting acquires identification information of the setting file stored in the storage part and displays the identification information as an option at a display part, when options for aggregate printing or a printing and bookbinding are displayed at the display part.
